(19) United States
(12) Patent Application Publication
(10) Pub. No.: US 2012/0115121 A1
(43) Pub. Date: May 10, 2012

(54) METHOD AND SYSTEM FOR TOUCH SCREEN BASED SOFTWARE GAME APPLICATIONS FOR INFANT USERS

(75) Inventor: Dan Dan Yang, Ottawa (CA)

(73) Assignee: RULLINGNET CORPORATION LIMITED, Hong Kong (HK)

(21) Appl. No.: 12/941,115

(22) Filed: Nov. 8, 2010

(51) Int. Cl. G09B 5/00

(52) U.S. Cl. 434/308

(57) ABSTRACT

Methods and systems for providing age appropriate activities to infant users. The age of the infant user is first determined and, based on the age, activities are presented to the infant user. Younger infant users will be presented with simpler and easier to understand activities requiring less manual dexterity and comprehension skills while older infant users will be presented with more complex tasks which may require more involved comprehension skills. These activities are presented by way of a touch screen user interface for ease of use by the infant user. Also disclosed are methods and systems for exposing the infant user to a variety of languages at an early age. These methods and systems may be incorporated as activities for older infant users.

### TECHNICAL FIELD

The present invention relates to game applications and, more specifically, the present invention relates to systems and methods for a game application for infant or near infant users that presents activities to these users based on their age by way of a computing device having a touch screen interface.

### BACKGROUND OF THE INVENTION

Recent developments in touch-screen based handheld and tablet computers have given rise to an increase in their use in everything ranging from business applications to online entertainment. One area which has, as yet, not been penetrated by the increasingly ubiquitous handheld computing devices is that of infant education or infant entertainment.

There are electronic devices which can be adapted for use by or are designed for use by children ages older than 3 or 4. However, there are currently no devices or associated computer games designed specifically for children under the age of 3 or 4.

Younger users, such as those younger than 3 or 4 years old, are still developing their cognitive abilities and thus need more direct interaction without the need for abstract thought. As such, larger icons, direct visual cues, direct and clear responses from devices in a way which infants can understand, would provide more accessible activities for the younger users. However, it should be noted that game activities are preferably designed for the various age groupings among the infant users. As an example, activities which are suitable for users 2-3 years old would not be suitable for users that are only 6 months old.

In addition to the above, it is preferable that the activities change as the user ages and his or her cognitive abilities develop. As the infant user develops, not only is he or she capable of more complex activities but he or she can also understand more. Furthermore, it should be noted that there are no computer software based products which help develop the language capabilities of infant users in different languages. As is well-known, infants and youngsters are more susceptible to learning languages than their older counterparts.

It is also preferable that an interface suitable for infant users be used in devices designed for such young users. A touch screen interface would simplify matters as infant users can simply touch the screen to interact with the software as opposed to having to manipulate keyboards and/or mice.

Unfortunately, there are currently no products which provide age appropriate game activities for infant users. Not only that, but no products are available that provide exposure to multiple languages to infant users. There is therefore a need for such products.

### SUMMARY OF INVENTION

The present invention provides methods and systems for providing age appropriate computer software based activities to infant users. The age of the infant user is first determined and, based on the age, activities are presented to the infant user. Younger infant users will be presented with simpler and easier to understand activities requiring less manual dexterity and comprehension skills while older infant users will be presented with more complex tasks which may require more involved comprehension skills. These activities are presented by way of a touch screen user interface on a computer or computing device for ease of use by the infant user. Also disclosed are methods and systems for exposing the infant user to a variety of languages at an early age. These methods and systems may be incorporated as activities for older infant users.

In a first aspect, the present invention provides a method for use in providing entertainment and educational content and activities to infants, the method comprising:

a) determining an age of an infant user

b) determining an activity to be presented to said infant user, said activity being based on said age of said infant user

c) as part of said activity, providing an infant user with visual cues and visual indicia by way of a computing device monitor having a touch screen interface, said visual cues and visual indicia being used for said activity;

d) receiving input from said infant user through said touch screen interface, said input being for interacting with at least one visual cue on said computing device monitor;

e) providing a response to said input, said response being appropriate to said age of said infant user such that said response is understandable for said infant user;

wherein said infant user is less than four years of age.

In a second aspect, the present invention provides a method for use in providing entertainment and educational content to infant users, the method comprising:

a) providing an infant user with visual cues and visual indicia by way of a computing device monitor having a touch screen interface, said visual indicia representing real-world items;

b) receiving input from said infant user through said touch screen interface;

c) determining if one of said visual indicia representing real-world items has been activated

d) in the event a specific one of said visual indicia has been activated, aurally identifying a real-world item represented by said specific one of said visual indicia.

### BRIEF DESCRIPTION OF THE DRAWINGS

The embodiments of the present invention will now be described by reference to the following figures, in which identical reference numerals in different figures indicate identical elements and in which:

FIG. 1 is a schematic illustration of a screenshot showing an activity which may be used with one aspect of the invention;

FIG. 2 is a schematic illustration of a screenshot of a variant of FIG. 1;

FIG. 3 is a schematic illustration of a screenshot of another variant of the activity illustrated in FIG. 1;

FIG. 4 is a schematic illustration of another activity which may be used with another aspect of the invention;

FIG. 5 is a schematic illustration of a screenshot of an environment in which another activity may be executed;

FIG. 6 is a schematic illustration of another environment which may be used with the invention;

FIG. 7 is a schematic illustration of a further environment which can be used with another aspect of the invention;

FIG. 8 is a schematic illustration of a music environment for use with an aspect of the invention;

FIG. 9 is a schematic illustration of a variant of the environment of FIG. 4;

FIG. 10 is a schematic illustration of a variant of the environment of FIG. 5; and

FIG. 11 is a schematic illustration of a variant of the environment of FIG. 7.

### DETAILED DESCRIPTION OF THE INVENTION

The following description and attached diagrams are provided as examples of possible configurations and functionalities of software which fall under the scope of the present invention. They are not to be taken as in any way limiting the scope of the present invention.

As noted above, there is a need for entertainment and educational software applications for toddlers or infants under the age of 3 or 4. Such infant users will, of course, have special needs that the software applications will need to address. As an example, these infant users may not be completely able to use and/or manipulate regular I/O interfaces such as keyboards and mice. These infant users will, however, be able to use touch screen interfaces and it is these interfaces that will be the preferred interface for such software.

Another possible special need for infant users is their limited visual acuity. As such, such software would need large, easily visible icons and visual cues and indicia so that they may be easily seen and perceived by the infant users.

It should be noted that ease of use of the software for the infant users, such as the large icons and other visual indicia and the touch screen interface, are not the only preferable features of the software. The activities presented by the software should also be very simple, easy to understand, and accessible to the infant users. As such, activities such as color matching, identifying and matching simpler shapes, images, and icons would be ideal for the infant user using the software. Also, simple musical matching, musical instrument identification, and possibly simple musical instrument simulation may be presented to the infant user.

To simplify the activities further so that they are accessible to infant users, a reward system that is readily identifiable and applicable to infant users may also be presented as part of the software. A reward system that provides emotionally positive indications of the infant user's performance may be used when the infant user's input causes a desirable result (e.g. matching one icon with another). Rewards such as a smiling avatar (a smiling or happy face), happy music, upbeat music or music fragments, sounds of celebration, a laughing sound, a happy animation (e.g. a dog playing, a child happily playing, bright colors flashing, etc.), the sound of clapping, providing access to other activities/areas of the software application, and other emotionally positive indications would be more accessible to the infant user. Similarly, when the infant user enters an undesirable input (i.e. the infant user's input is “incorrect” or is not what is desired by the application) emotionally negative indications of the infant user's performance may be used. These emotionally negative indications may take the form of a frowning avatar, a sad face, jarring sounds such as a dog barking angrily, a downbeat tune, a loud noise, a large flashing “X” and other clearly negative indications.

As noted above, it is preferable that activities in game software be designed to be age appropriate or age specific for infant users. In one embodiment, activities for younger infant users (e.g. infant users up to 6 months old or up to 1 year old) are simple and appropriate for their cognitive and comprehension capabilities while activities for older infant users (e.g. 12-24 months old) are more complex and, again, are appropriate for their cognitive and comprehension capabilities.

For the present invention, it is contemplated that the infant user be younger than 3-4 years old. Younger infant users, those that are younger than 12-24 months old, would be presented with simple activities. Older infant users, those between 12-24 months old would be presented with more complex activities. Infant users older than approximately 24 months old and younger than approximately 36-48 months old would be presented with the most complex activities contemplated for the present invention. It is, however, contemplated that infant users for the invention will be not much older than 3 years old.

The present invention is preferably implemented with devices that have a touch screen interface. As noted above, regular I/O devices such as keyboards and mice are not accessible nor are they comfortably usable by infant users. A touch screen interface, one which uses a monitor that also doubles as the input interface, would address these issues. Infant users can merely touch the touch screen interface to interact with the software.

Two approaches are possible to adjust age or ability appropriate activities. The first approach is to design different activities for the different groups, i.e. much simpler activities for younger infant users and more complex activities for older infant users. While this approach is useful, it does require more software development time as well as a learning curve for the infant users. As the infant user gets older, he/she will need to learn the new activities designed for the older infant users. As an example, for very young infant users, the activities in the software or system can be set to an “explore” mode where there are no clearly defined goals or hurdles. In this example, the very young infant user is presented with objects, colors, shapes, etc. and, when the very young infant user touches or activates these objects, colors, shapes, etc., a voice recording identifies the object, color, or shape activated. This would then familiarize the very young infant with the objects. Older infant users would be presented with different activities.

The other approach to the above is to design specific activities which are accessible to all infant users and to simply adjust the “difficulty” or complexity of the activities based on the infant user's age and/or cognitive and comprehension abilities. As an example, the software can (possibly with the assistance of an adult user) ask the infant user to identify an ugly duckling among a group of regular ducklings. For very young infant users, the ugly duckling pops or moves much slower than the other ducklings. As the infant user gets older, the speed at which the ugly duckling moves can be increased, thereby providing more of a challenge for the growing infant user. With the above approach, the same activity can be adjusted to involve more complex actions and/or concepts for older infant users. Such an approach would involve less development time and less of a learning curve for the infant users.

Both of the approaches noted above are explained below in association with the present invention. Both approaches may be preceded with the software prompting an adult user for the infant user's age in months or years. Or, in one variant, the software application would have a record of the infant user's age and would track the passing of time and, as such, can determine the current age of the infant user. This way, the software can automatically adjust the complexity or difficulty level of the activities to the calculated age of the infant user. As an example, the software would be told of the infant user's birth date and, based on the current date, the software can automatically determine the infant user's age (in months or years) and can automatically adjust the activities presented to the infant user. The software can thus present one set of activities to the infant user when the infant user is 6 months old and the software can automatically adjust the activities to a different level when the infant user is 18 months old.

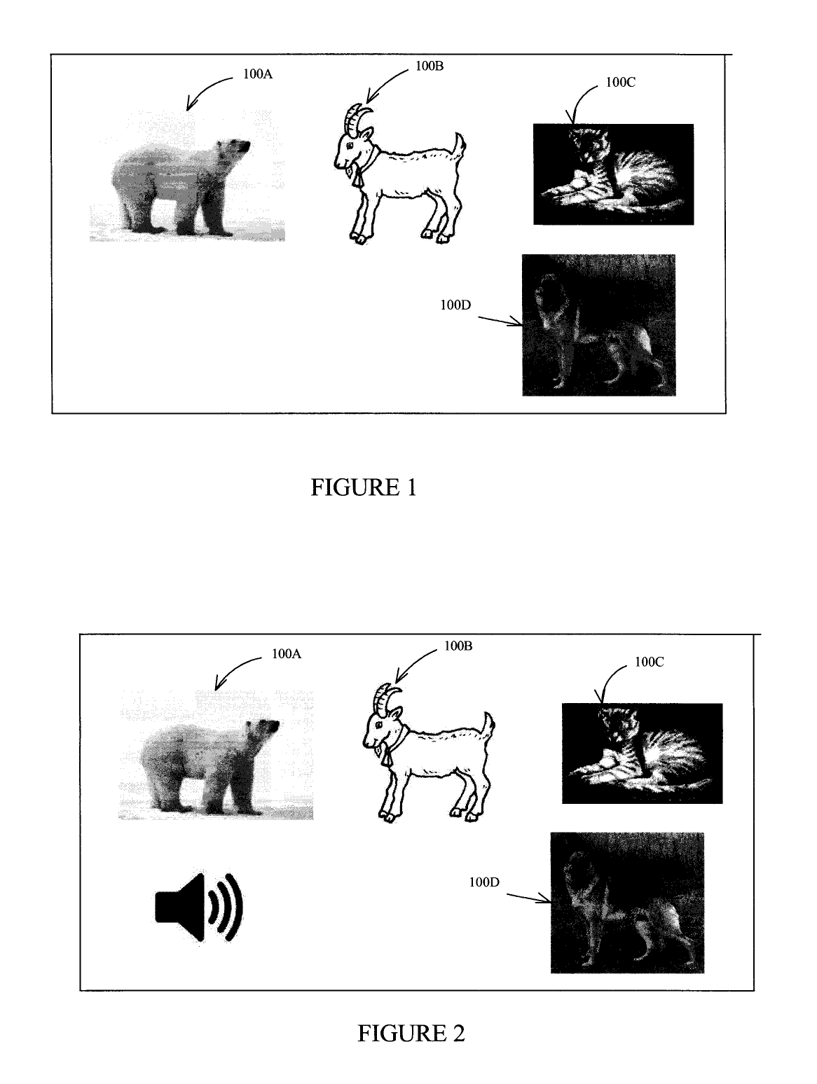

Using the first approach, different activities may be used for differing age groups. As an example, for younger infant users, an exploration mode of gameplay may be used. This may involve presenting the infant user with a screen having visual indicia and/or visual cues which represent everyday items. The younger infant user would interact with the visual cues and indicia by touching the touch-screen monitor in the area associated with the visual cue or indicia. A response from the game system is then presented to the younger infant user. The response can be a multitude of possibilities but, in one variant, a playback of a sound associated with the real-world item is presented to the younger infant user. As an example, FIG. 1 shows a number of animals presented on the screen to a younger infant user. When the infant user touches one of the animals, a sound associated with the animal activated is played, e.g. when the dog picture is activated, a barking sound is played back.

For slightly older infant users, instead of presenting the same activity (i.e. touching and thereby “activating” the icon or visual indicia/cue), the game system would require the older infant user to activate and drag the icon to a different part of the screen before a response is presented to the infant user. As an example, in FIG. 2, the same animals are presented to the older infant user but, this time, instead of merely having to touch the animal picture to activate the sound, the infant user has to touch and drag the animal picture to the speaker icon at the lower left corner of the screen. The older infant user therefore has to learn to interact in a more complex manner with the software to receive a response as opposed to the younger infant user who merely has to touch the relevant icon.

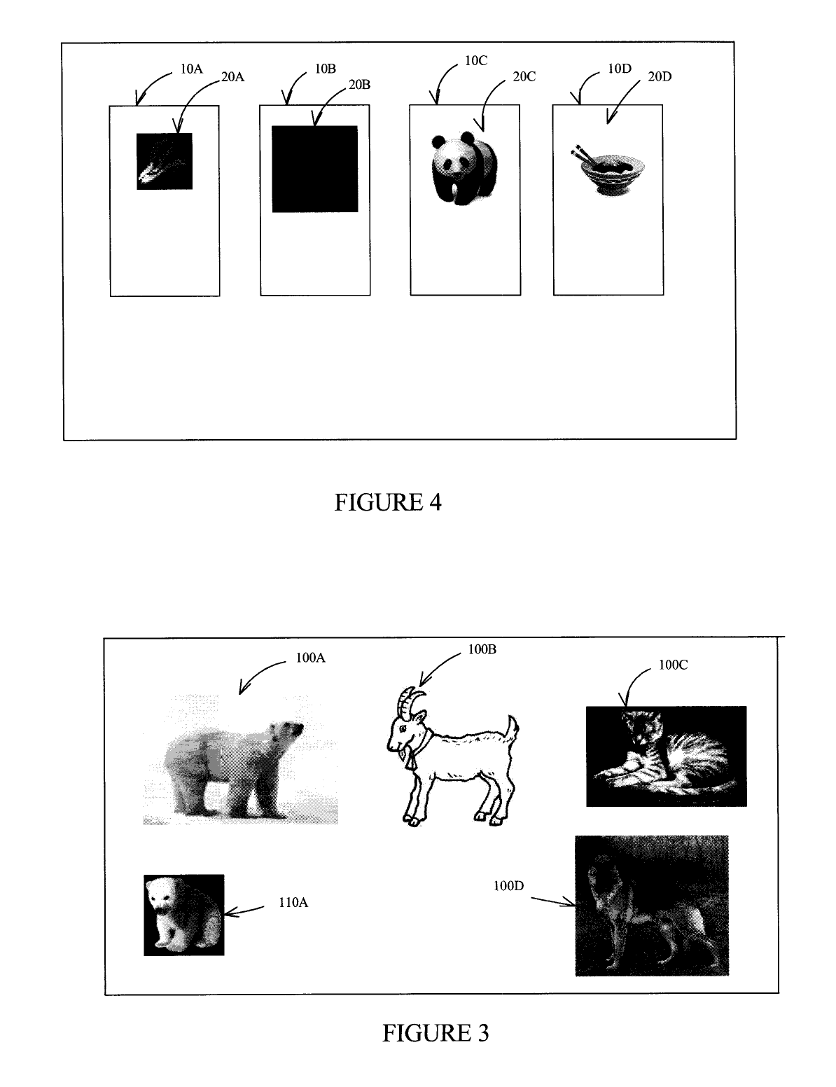

For even older infant users, an even more complex activity may be one that involves matching one icon/picture with another. As an example, in FIG. 3, the older infant user would need to match the baby animal (shown in the lower left corner of the user interface screen) with its mother animal. This can be done by dragging the baby animal picture to the mother animal picture or the mother animal picture can be dragged to the baby animal picture.

Using the second approach noted above, a simple activity may be used for younger infant users. This activity may be as outlined above—a user interface screen is presented to the infant user with the screen having a multitude of animal icons or pictures (See FIG. 1). When the infant user touches or activates one of the animal icons a sound associated with the animal is played back (e.g. when the dog picture is activated, a barking sound is played back). For older infant users, instead of merely playing back the sound associated with the animal, a human voice identifying the animal may also be played. As an example, after the barking sound is played when the dog picture is activated, a recording of a human voice would say “dog”. The older infant user would thus be provided with a more complex idea—that of the name of the animal as opposed to merely the sound associated with the animal. Even older infant users (such as those 3 or 4 years old) may be presented with a human voice identifying the animal in complete sentences (e.g. “This is a dog. The sound it makes is (playback of barking)”) when the animal picture is activated. In this approach, the activity is the same (activating the animal picture by touching the picture) yet the comprehension level needed to understand the activity increases as the infant user ages.

This phased approach to entertainment and educational gaming activities for infant users would involve very simple activities for younger infant users and more involved activities for older infant users. Younger infant users would be provided with more experiential activities that would promote exploration. As an example, in FIG. 4, a number of doors would be presented to the younger infant user. As can be seen, the infant user is provided with a number of doors 10A, 10B, 10C, 10D of varying colors and, preferably, with varying icons 20A, 20B, 20C, 20D with each icon representing the activities accessible by activating the specific door. By touching one of the doors, the infant user would be granted access to the activities represented by the icon on the door which was activated. A vegetable icon 20A would represent a farm area and farming related activities would be accessible. A trumpet icon 20B would represent a music area and music related activities would be accessible. An animal icon 20C would represent a zoo area and zoo or animal related activities would be accessible. A dishes icon 20D would represent a kitchen area and kitchen or food related activities would be accessible.

Once one of the doors has been activated, the younger infant user would then be presented with an environment with everyday items or commonplace events. As an example, for the door with the animal icon, the screen in FIG. 1 would be presented and the activity outlined above for FIG. 1 would be executed.

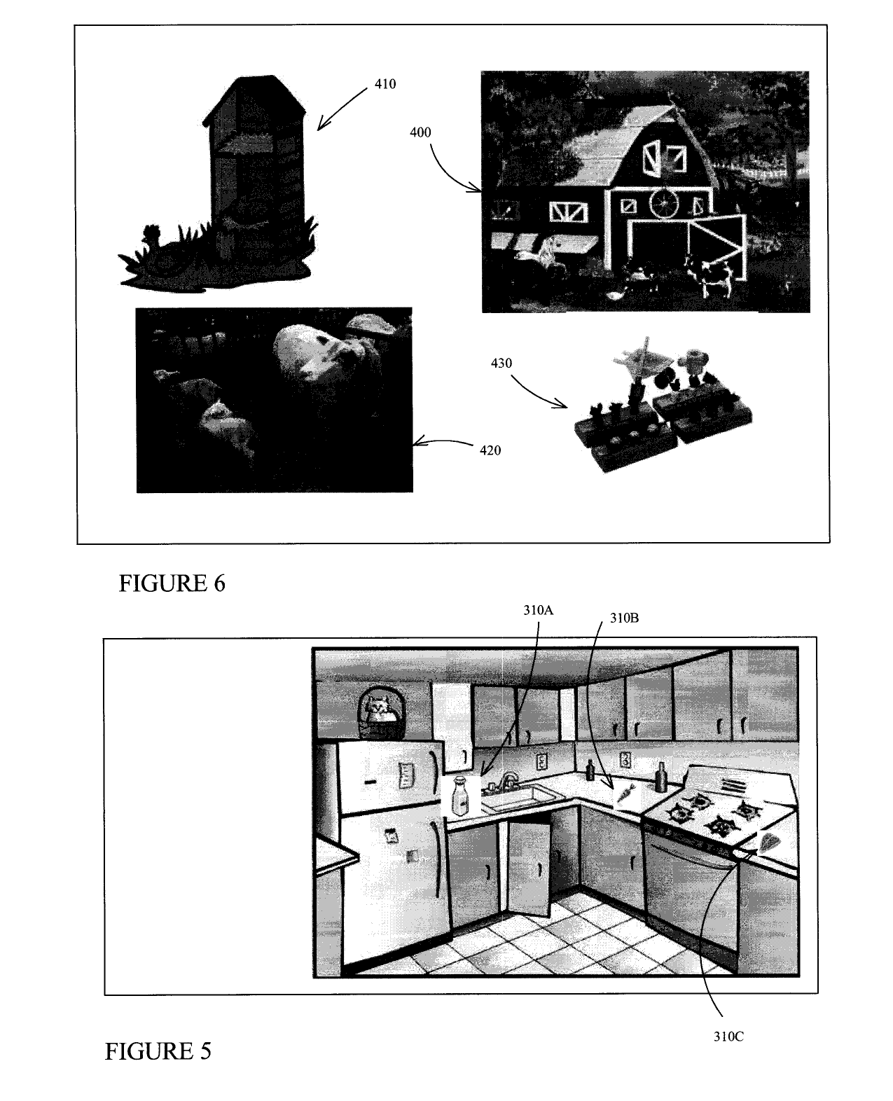

In another environment, such that that accessible through the food or kitchen related icon 20D, would present the infant user with a kitchen environment (See FIG. 5). FIG. 5 is a schematic of a screen shot of a kitchen environment or kitchen area illustrating the invention. In one implementation, the kitchen environment is represented as being a typical kitchen with cupboards, appliances, and a sink area. Various food items 310A-310C are scattered throughout the kitchen environment as well as the assorted kitchen appliances. Touching any of the appliances or any of the food items may cause playback of sounds associated with that appliance or food item. As an example, touching the sink would produce a sound of running water, touching the refrigerator would produce the sound of a refrigerator opening and closing, and activating the closets would produce the sound of wooden doors opening and closing. Touching the bottles would produce the sound of a bottlecap being popped open or of a twist top bottle (containing a carbonated drink) being opened.

The farm area represented by the door 10A would have similar activities for younger infant users (see FIG. 6). In one implementation, the farm environment may be accessed by the infant user by activating the door with the vegetable patch icon using the touch screen interface. In one implementation, the farm is represented as having a barn area 400, a chicken coop 410 with multiple chickens in nests, a lamb holding pen 420, and a vegetable garden area 430.

In the farm area, when the infant user activates any of the areas of the farm environment, a corresponding sound may be heard from the game system. As an example, when the barn area's cow icon is activated, a cow may be illustrated and a sound of the cow's mooing may be played for the infant user. When the lamb holding pen is activated, a lamb is presented to the infant user and a sound associated with the lamb (such as a lamb's braying) may be played for the infant user. Similarly, for the chicken coop area, activating the icon presents the infant user with a number of chickens on their nests. The infant user can activate each chicken by touching the screen where the chicken is located. This would cause a sound of chickens clucking to be played back to the infant user.

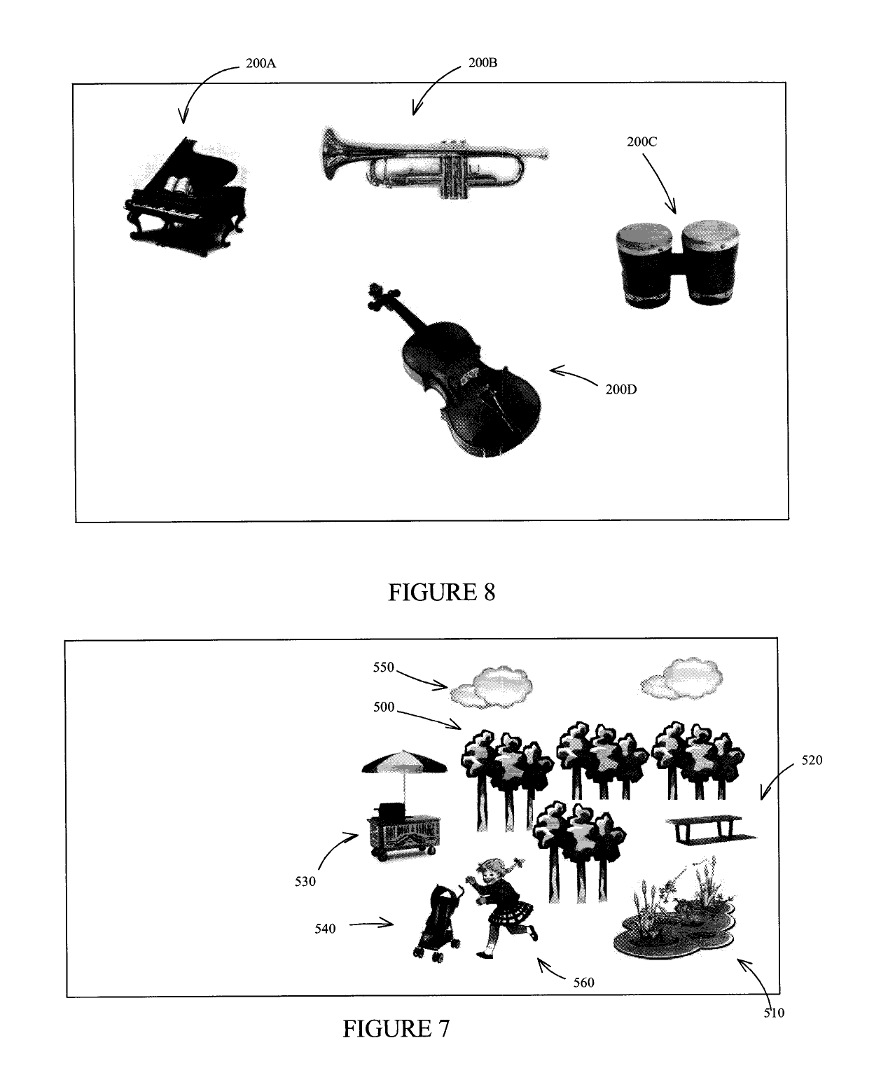

Another possible environment or area is that of the park environment. Referring to FIG. 7, the park environment would have a multitude of icons representing objects normally seen in or from a park. Trees 500, a pond 510, bench 520, hotdog cart 530, stroller 540, clouds 550, and people 560 are illustrated. For this environment, younger infant users would, again, activate the various icons to hear the associated sounds. As an example, activating the trees would play the sound of leaves rustling in the wind, activating the child would play sounds of children playing, activating the pond would play the sound of splashing water.

A music environment (FIG. 8) may be accessed by the younger infant user by activating the door with the trumpet icon. FIG. 8 is a schematic of a screen shot of a music environment. As can be seen from FIG. 8, icons 200A, 200B, 200C, 200D illustrate different musical instruments. Activating each of the different musical instruments (using the touch screen interface) would cause a short tune of the instrument playing to be played.

For older infant users, the activities associated with the screenshots in FIGS. 3-8 can be modified/adjusted to take into account the more developed cognitive and comprehension abilities of the infant users.

The activity associated with FIG. 3 can be seen as a development of the simpler activity associated with FIG. 1 as explained above. Instead of simply hearing the sounds associated with the animals activated, the infant user (when interacting with FIG. 3) now has to match the baby animal with its corresponding mother animal.

As another variant of the activity associated with FIG. 1, instead of simply playing the sound associated with the animal, older infant users could be presented with the name of the animal as explained above. More complex language may also be used for even older infant users when presenting the names of the animals as explained above. The same variant can also be applied to the other environments and the items in them. Older infant users can activate each item in the various environments and be presented with not just the sound associated with the item but with an identification of the item.

It should also be noted that older infant users may also be presented with more complex activities associated with the various environments illustrated in the Figures.

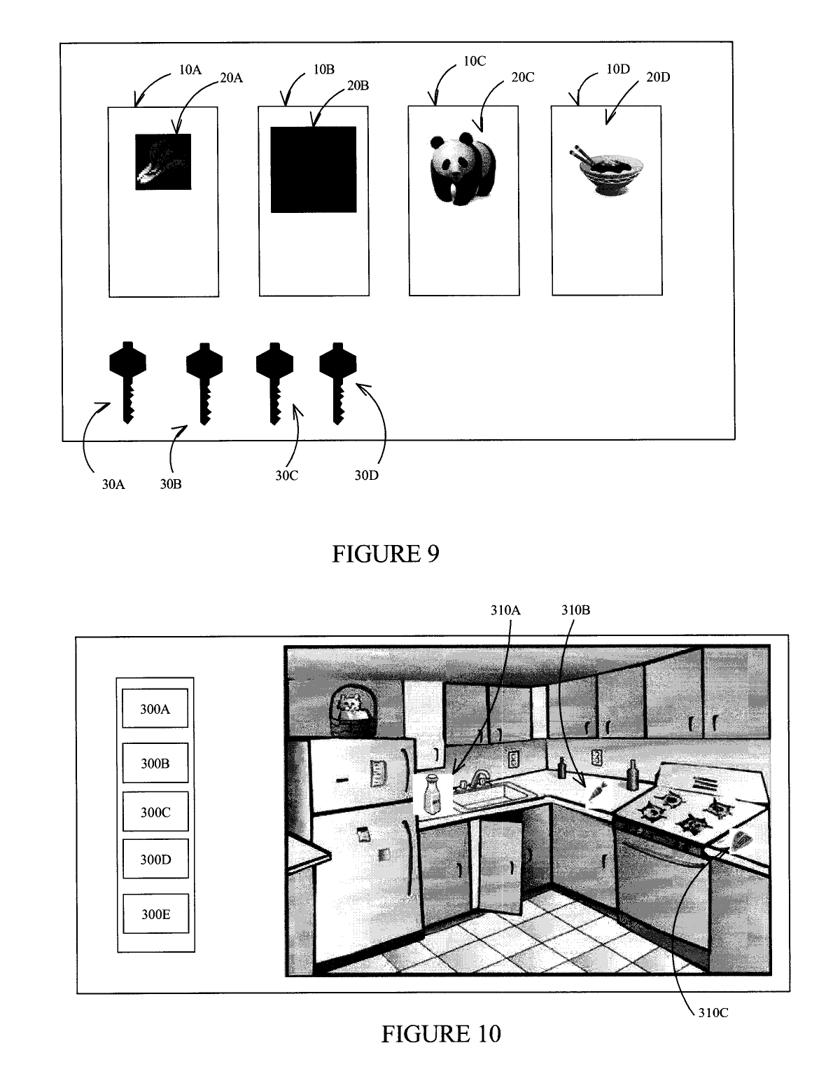

Referring to FIG. 9, a more complex variant of the activity associated with the screen illustrated in FIG. 4 is presented. Similar to FIG. 4, there is presented in FIG. 9 a number of doors 10A, 10B, 10C, 10D of varying colors and, preferably, with varying icons 20A, 20B, 20C, 20D with each icon representing the activities accessible by activating the specific door. A number of keys 30A 30B 30C 30D are also provided at the bottom of the screen. Each key has a different color and each key color corresponds to a color of one of the doors 10A-10D. The infant user can press and drag each of the keys 30A-30D to one of the doors 10A-10D. If the infant user drags a key to the door with the same color as the key, the activities associated with the environment represented by the door becomes accessible to the infant user. In addition to the presentation of the activities an emotionally positive indication, such as a happy sound, a smiling face, or any one of a number of events which would elicit an emotionally positive response from the infant user, may be presented to the user. If the infant user were to drag a key to a door whose color does not match that of the key, then an emotionally negative indication would be presented to the infant user. The user would then be allowed to enter another input by dragging another key to another door.

As a variant for older infant users, the activities associated with FIG. 5 may be adjusted. Referring to FIG. 10, in one activity available in the kitchen area, a number of slots 300A-300E are presented at the bottom of the screen. Various food items 310A-310C are scattered throughout the kitchen environment. The infant user can drag any of the food items 310A-310C to the slots 300A-300E and, when a nutritionally balanced combination is in the slots, then an emotionally positive indication is presented to the infant user. If all the slots are filled and a nutritionally balanced combination is not found within the food items in the slots, then an emotionally negative indication is presented and the slots are emptied with the food items being re-scattered throughout the kitchen environment.

Again for older infant users, the activities associated with FIG. 6 can be adjusted to account for the more developed cognitive and comprehension abilities of the infant user. When the infant user activates any of the areas of the farm environment, a different activity is activated and a new screen may be presented for that activity.

When the barn area is activated, a cow may be illustrated and the infant user can, using the touch screen, simulate milking the cow by simply touching the cow. A suitably emotionally positive animation is then played along with suitably emotionally positive sounds and music. The resulting milk may then be shown as being bottled and/or placed in a truck.

When the lamb holding pen is activated, a lamb is presented to the infant user. By touching the lamb, the infant user activates a simulation of the lamb being sheared of its wool. An animation of the lamb being sheared can then be presented to the infant user. Again, suitably emotionally positive indications (e.g. happy music, happy sounds, the sound of a lamb braying, etc., etc.) may be presented to the infant user simultaneous to the animation being played.

For the vegetable garden area, when the infant user activates this area, a vegetable garden is presented to the infant user. The infant user can then pick the vegetables in the garden and place them in a basket in a corner of the screen. The vegetables are originally shown as sprouting from the ground with only their tops showing. When the infant user activates each vegetable top by touching its location on the screen, a full representation of the appropriate vegetable is presented and this can be dragged to the basket at the side of the screen. For each vegetable “picked” from the garden, a suitably emotionally positive indication or reward can be presented to the infant user. For this activity, the emotionally positive indication or reward may be a cheering sound, a clapping sound, or any other suitably happy sound and/or animation may be used. Once the basket is full, another animation—this time that of filling a stall in a market with the vegetables in the basket—may be presented to the infant user.

For the chicken coop area, activating the icon presents the infant user with a number of chickens on their nests. The infant user can activate each chicken by touching the screen where the chicken is located. This activates an animation which would show whether there is an egg underneath the chicken. Each egg discovered would cause a suitably emotionally positive indication or reward to be presented the infant user. Each egg can then be shown as being placed in an egg container.

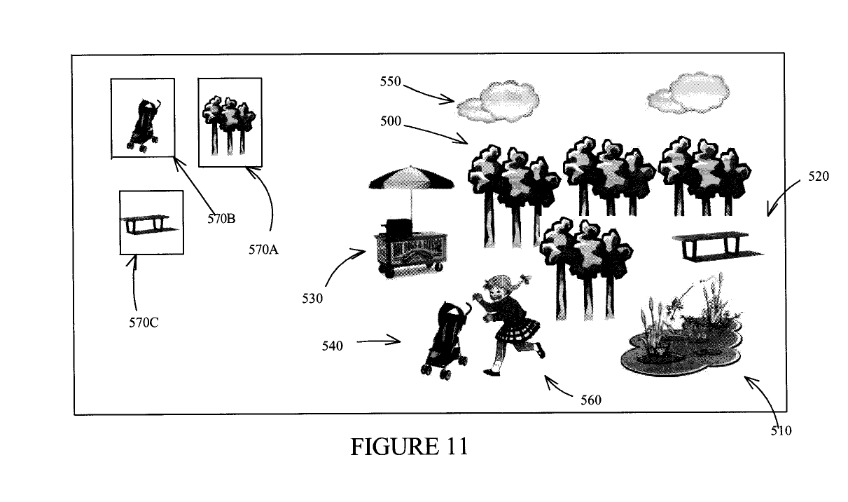

Referring to FIG. 11, the activities associated with FIG. 7 may also be adjusted for older infant users. FIG. 11 is identical to FIG. 7 except for the addition of flash cards 570A-570C which illustrate things found on the screen for the environment. The items or things illustrated on the flash cards 570A-570C would then need to be matched to the matching card. As an example, the infant user can drag flash card 570A illustrating a tree to the tree 500. When this occurs, a suitable reward can be presented to the infant user. If, on the other hand, the infant user incorrectly matches a card with an object (e.g. flash card 570B illustrating a person is dragged to the stroller 540), then a suitable punishment is presented to the infant user. In one variant of the activity, the reward may be presented to the infant user after he/she matches a number of flash cards. After a match is made, the matching card may be replaced by another, random card.

As a variant to the above, the infant user can be exposed to at least one other language using the present invention. The infant user can be exposed to the vocabulary of one language as explained above where the activation of an icon or of visual indicia results in the playback of a recording identifying the item represented by the icon or visual indicia. To expose the infant user to another language, a reactivation (within a given time period) of the icon or visual indicia would result in the playback of a recording identifying the item represented by the icon or visual indicia in another language. As an example, if the infant user is presented with a picture of a chair, activating that picture would result in a playback of a voice saying “Chair”. If the infant user touches or reactivates the picture again, the result would be the playback of a voice saying “chaise” or the French word for “chair”. Of course, languages other than English and French can be used. One language would be the primary language (the first language presented) while the other language would be the secondary language (the second language presented).

Other activities would build on the above concept of exposing the infant user to a second language. For older infant users, instead of a single word describing the item (e.g. “chair”), a sentence would be heard by the infant user from the system (e.g. “This is a chair.”). Reactivating the icon/picture/visual indicia would produce, instead of a single word in another language (e.g. “chaise”), a sentence in the other language (e.g. “C'est une chaise”). As the infant user grows older, more complex language concepts and structures may be used to identify the items. One example of this may be a simple story in two languages. In this example, using the screen in FIG. 7, an infant user activating the girl icon on the screen would result in the playback of an English sentence describing the girl and/or the scene (e.g. “The girl is in the park”). Reactivating the girl icon would result in the playback of the same sentence but in another language (e.g. “La fille est dans le parc”).

It should be noted that, using the above, the infant user may be exposed to languages such as English, French, Mandarin, Cantonese, Japanese, German, Italian, Spanish, Korean, Dutch, or any of a multitude of other languages. It should also be noted that, while the above examples use only two languages (a primary and a secondary language), other configurations using more than two languages are possible. As an example, the initial activation of a specific picture or icon may produce an English identification of the item. The second activation of the same picture may produce a French identification of the item. A third activation of the same icon could produce a Japanese or a German identification of the item.

It should further be noted that, while the above description uses items as examples for the icons/visual indicia, other things may also be presented to the infant user to broaden his/her vocabulary or to expand his/her range of experiences. Body parts, everyday items, different vehicle types, animals, furniture, outlines of countries or other geographical items, and different toys may be used.

A variant of the above may be the use of songs in different languages. An infant user may, by activating a specific icon or visual indicia, cause the playback of a specific song in one language. Reactivating the same icon would cause the playback of the same song but with the lyrics in another language.

It would be preferred if the system implementing the above would be user configurable such that an adult user can configure the primary and the secondary languages. Such a feature would allow the adult user to select which languages the infant user would be exposed to.

The activities described above and a software application that includes at least a few of these activities would serve to promote a more active, curious, and hopefully healthier lifestyle for the infant user as he or she grows older. The activities mimic healthy lifestyle choices—such as interacting in a park environment or a farm environment—and also promote a healthier diet by inculcating healthy eating habits.

The method steps of the invention may be embodied in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory means such computer diskettes, CD-Roms, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language For example, preferred embodiments may be implemented in a procedural programming language (e.g.“C”) or an object oriented language (e.g.“C++”, “java”, or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

1. A method for use in providing entertainment and educational content and activities to infants, the method comprising:
a) determining an age of an infant user;
b) determining an activity to be presented to said infant user, said activity being based on said age of said infant user;
c) as part of said activity, providing an infant user with visual cues and visual indicia by way of a computing device monitor having a touch screen interface, said visual cues and visual indicia being used for said activity;
d) receiving input from said infant user through said touch screen interface, said input being for interacting with at least one visual cue on said computing device monitor;
e) providing a response to said input, said response being appropriate to said age of said infant user such that said response is understandable for said infant user;
wherein said infant user is younger than four years old.

2. A method according to claim 1 wherein said response comprises providing a reward to said infant user in the event said input is a desirable input, said reward being for eliciting a positive reinforcement reaction from said infant.

3. A method according to claim 1 wherein said response comprises providing to said infant user an emotionally negative indication of said infant user's performance using said monitor.

4. A method according to claim 1 wherein at least one of said visual indicia represents a real-world item and said activity is implemented by executing an activity method comprising:
b1) determining if at least one visual indicia representing a real-world item has been activated;
b2) in the event said at least one visual indicia in step b1) has been activated, said response comprises aurally identifying said real-world item represented by said visual indicia.

5. A method according to claim 4 wherein step b2) further comprises aurally identifying said real-world item using a first language and aurally identifying said real-world item using a second language when said visual indicia is activated again.

6. A method according to claim 1 wherein at least one of said visual indicia represents a musical piece with lyrics and wherein an activation of said visual indicia representing a musical piece causes a playback of said musical piece.

7. A method according to claim 6 wherein said musical piece has lyrics in at least two languages and said activation of said visual indicia causes a playback of said musical piece in a first language and a subsequent activation of said visual indicia causes a playback of said musical piece in a second language.

8. A method according to claim 1 wherein at least one of said visual indicia represents a real-world item and said activity is implemented by executing an activity method comprising:
b1) determining if at least one visual indicia representing a real-world item has been activated;
b2) in the event said at least one visual indicia in step b1) has been activated, said response comprises causing a playback of a recording of a sound associated with said real-world item.

9. A method according to claim 8 wherein said sound comprises a sound made when said real-world item is used.

10. A method according to claim 1 wherein said visual cues and visual indicia includes a background scene in which said real-world items are incorporated in said scene.

11. A method according to claim 8 wherein said real-world items are different animals.

12. A method according to claim 4 wherein said real-world items are different human body parts.

13. A method according to claim 4 wherein said real world items are aurally identified using a first language.

14. A method according to claim 13 wherein said real-world items are aurally identified using a second language when said specific one of said visual indicia is activated a second time.

15. A method according to claim 11 further comprising playing back an audio file recreating a sound associated with an animal represented by a visual indicia which has been activated.

16. A method according to claim 8 wherein said method further comprises aurally identifying said real-world item using simple language for younger infant users and more complex language structures for older infant users.

17. A method according to claim 16 wherein said real-world items are identified using single expressions for younger infant users.

18. A method according to claim 16 wherein said real-world items are identified using complete sentences for older infant users.

19. A method according to claim 1 further comprising adjusting an activity based on said age of said infant user such that younger infant users are presented with simple activities while older infant users are presented with more complex activities.
